(19) United States
(12) Patent Application Publication
(10) Pub. No.: US 2007/0279603 A1
(43) Pub. Date: Dec. 6, 2007

(54) Video device that sets extended device connected to interface, display method by the video device and processing program for the video device

(75) Inventor: Takashi Akutsu, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/810,333

(22) Filed: Jun. 5, 2007

(30) Foreign Application Priority Data
Jun. 6, 2006 (JP) 2006-156912

(51) Int. Cl. G03B 21/00

(52) U.S. Cl. 353/122

(57) ABSTRACT

When an extended device is connected to an USB interface, it is determined whether a plug and play function is on. If so, a selector is switched so as to receive a video signal from the extended device, and items for the extended device are displayed in a main menu. When the plug and play function is off, the inputs to the selector are not switched by the plug and play function. Then the items for the extended device are displayed in a menu. When the extended device is connected to the USB interface, the main and function menus and the direct key functions are changed depending on the functions of the extended device.

### BACKGROUND OF THE INVENTION

1. Field of the Invention

The present invention relates to video devices and more particularly to a video device that includes a projector to which an extended device is connectable over a digital interface such as, for example, a USB (Universal Serial Bus) interface. The present invention also relates to display methods by and processing programs for the video devices.

2. Background Art

Projectors are used to project an image of a large picture on a screen for movie watching, presentations and education. Some projectors have a USB interface to which a respective one of various extended devices is connectable. The extended devices include high-precision projection cameras that capture an image of a draft, memories for video data and devices to access video data of a server, using a wireless LAN (Local Area Network).

For example, as disclosed in unexamined Japanese patent publication 2005-182533, the USB interface is capable of specifying a device connected thereto to realize a plug and play function which causes the connected device to perform its own functions. That is, when an extended device is connected to the USB interface, use of the plug and play function allows the inputs to the projector is switched such that an image received from the connected extended device to be selected automatically.

When an extended device is connected to the USB interface and the projector is projecting a video if the plug and play function is effective at all times, however, the output from the extended device is forced to be employed undesirably as an input to the projector. More specifically, assume, for example, that the projector is projecting a replayed picture from a DVD (Digital Versatile Disc) player. Further, assume that a projection camera is connected as an extended device to the USB interface. If in this case the plug and play function is effective, the picture replayed from the DVD player would abruptly be replaced undesirably with a picture captured by the projection camera.

### SUMMARY OF THE INVENTION

It is therefore an object of the present invention to provide a video device capable of appropriately setting the plug and play function when an extended device is connected to the interface of the video device such that an undesirable image does not appear on the display. Another object of the present invention is to provide a display method by and a processing program for the video device.

In order to achieve the above objects, the present invention provides a video device including an input terminal over which a video signal is received externally, a digital interface to which an extended device that produces a video signal is connectable, and a projecting unit that projects on a screen a video based on the video signal from the terminal or the video signal from the extended device. In accordance with the video device, a device connection detector detects that the extended device is connected to the digital interface. A device type determiner determines a type of the extended device connected to the digital interface. Responsive to the device connection detector and the device type determiner, a plug and play function unit selects the extended device. An on/off setting unit can set the plug and play function unit to on or off. Responsive to the selection of the extended device connected to the digital interface and the plug and play function unit being set to on, an input/output switch selects the video signal from the extended device. Responsive to the selection of the extended device connected to the digital interface and the plug and play function unit being set to off, the input switch fails to select the video signal from the extended device.

According to the present invention, when the extended device is connected to the digital interface, the plug and play function can be turned on/off. When the plug and play function is on and the extended device is connected to the digital interface, the extended device is automatically determined and the inputs to the projector are automatically switched so as to select a video signal from the extended device. When the plug and play function is off, a desired video excluding that from the extended device can be selected. Even if an extended device is connected to the digital interface while a video is being projected, the inputs to the projector are prevented from being compulsively switched to those from the extended device.

In accordance with the present invention, the video device may further comprise an indicator that sets operation of the extended device and a setting unit, responsive to the extended device being connected to the digital interface, for validating the indicator.

In accordance with the present invention, the video device may further comprises a main menu indicator that sets operation of the extended device, and a menu setting unit that, responsive to the extended device being connected to the digital interface, validates indication of the main menu indicator and that, responsive to the extended device being disconnected from the digital interface, invalidates the indication of the main menu indicator.

In accordance with the present invention, the video device may further comprise a function menu indicator that when the extended device is disconnected from the digital interface, indicates a function menu to set operation of the video device, and that when the extended device is connected to the digital interface, indicates a second function menu to set operation of the extended device.

In accordance with the present invention, the video device may further comprise a direct key that when the extended device is disconnected from the digital interface, sets operation of the video device, and that when the extended device is connected to the digital interface, sets operation of the extended device.

In accordance with the present invention, the video device may further comprise a function menu indicator that when the extended device connected to the digital interface is not selected, sets operation of the video device, and that when the extended device connected to the digital interface is selected, sets operation of the extended device instead of the first-mentioned function menu.

In accordance with the present invention, the video device may further comprise a direct key that when the extended device connected to the digital interface is not selected, sets operation of the video device, and that when the extended device connected to the digital interface is selected, sets operation of the extended device.

Thus, according to the present invention, the main menu, function menu and direct key functions are changed depending on whether or not the extended device is connected to the digital interface. Therefore, the extended device can be set in various stages, using a remote controller.

In accordance with the present invention, there is provided a video image displaying method in a video device for projecting and displaying a video image on a display screen based on a video image signal received externally over an input terminal or over a digital interface to which an extended device that produces a video signal is connectable. The method comprises the steps of detecting that the extended device is connected to the digital interface; determining a type of the extended device connected to the digital interface; detecting whether a plug and play function is on or off; and responsive to the extended device connected to the digital interface and the plug and play function unit set to on, selecting the video signal from the extended device, and responsive to the extended device connected to the digital interface and the plug and play function unit set to off, failing to select the video signal from the extended device.

The video image displaying method may further comprise the step of validating an indicator for setting operation of the extended device responsive to the extended device being connected to the digital interface.

In accordance with the present invention, there is also provided a software program product embodiment in a computer readable medium for performing the method.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram of a projector as an embodiment of the present invention;

FIG. 2 is a front view of a remote controller for the projector;

FIG. 3 illustrates a main menu displayed on a display of the projector;

FIG. 4 illustrates a function menu displayed on the display;

FIG. 5 is a block diagram of the projector;

FIGS. 6A and 6B are flowcharts of display of different menus to be performed when an external device is connected to or disconnected, respectively, from the projector;

FIGS. 7A and 7B are flowcharts of display of different function menus to be performed when the external device is connected to or disconnected, respectively, from the projector;

FIGS. 8A and 8B are flowcharts of change of the functions of direct keys to be performed when the external device is connected to or disconnected, respectively, from the projector;

FIG. 9 is a flowchart of change of the function menu to be performed when an input key selects the extended device; and

FIG. 10 is a flowchart of setting the functions of the direct keys to be performed when an input key selects a device.

### DETAILED DESCRIPTION OF THE PREFERRED EMBODIMENT

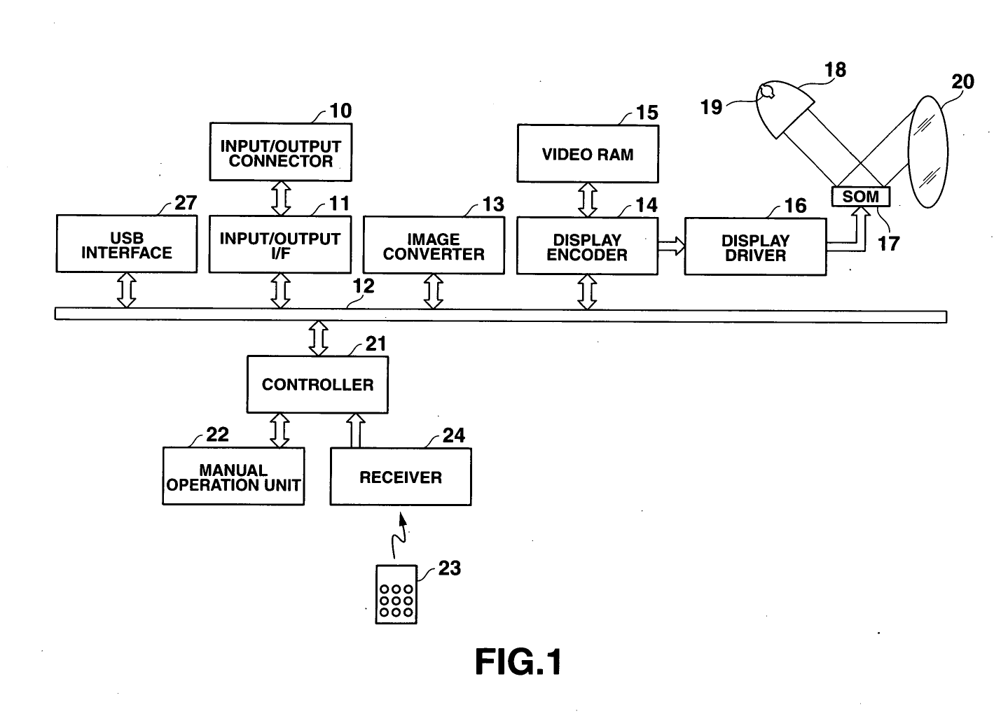

Referring to FIG. 1, a projector according to one embodiment of the present invention comprises an input/output connector 10 with many input/output terminals over which many video signals of different formats such as video inputs, S-video inputs, R, G, B, component video outputs are inputted/outputted.

A video signal from connector 10 is delivered via an input/output interface 11 and a bus 12 to a video converter 13 which converts a video signal of a respective format to a video signal of a predetermined format.

A video signal from image converter 13 is delivered to a display encoder 14, which loads the received image signal on a video RAM 15 and produces R, G, B (Red, Green and Blue) frame video signals for one frame in a time-divisional manner. These R, G and B video signals are delivered to a display driver 16. Display-encoder 14 has an OSD (On Screen Display) function to display, for example, a menu on a display screen (not shown). In synchronization of the R, G, B video signals, a wheel of R, G, B sectors is rotated.

Display-driver 16 drives a spatial optical modulation (SOM) element 17 with the time-divisional R, G, B frame video signals for one frame. SOM-element 17 includes a DMD element with many micro-mirrors disposed on a surface thereof where the respective angles of the micro-mirrors are changeable individually. When a signal is applied from display-driver 16 to SOM-element 17, the angles of the micro-mirrors and hence the courses of light reflected by the respective micro-mirrors are changed, thereby turning on/off the light beam in units of a pixel.

A light source lamp such as a superhigh pressure mercury lamp 19 disposed within a reflector 18 applies high-luminosity white light beam via the color wheel (not shown) to SOM-element 17, thereby forming an optical image. The optical image is then projected via a projection lens 20 against the screen (not shown).

A main controller 21 controls the whole projector. Main-controller 21 is connected to bus 12 and receives inputs from a manual operation unit 22 and also via a receiver 24 from a remote controller 23.

Connected to bus 12 is an USB interface 27 to which an extended device such as a high-resolution projection camera, a video data memory or an access device using a wireless RAN is connectable. Use of USB interface 27 allows the function of a plug and play executer 63 provided in main-controller 21 to determine the type of an extended device connected to USB interface 27 so as to select an input from the extended device. In the projector, the plug and play function can be set so as to be turned on/off.

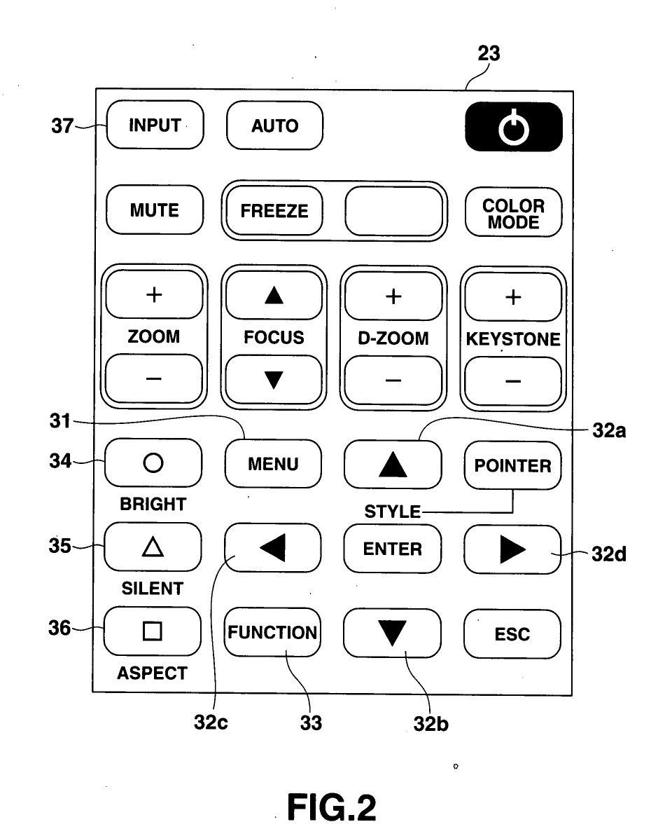

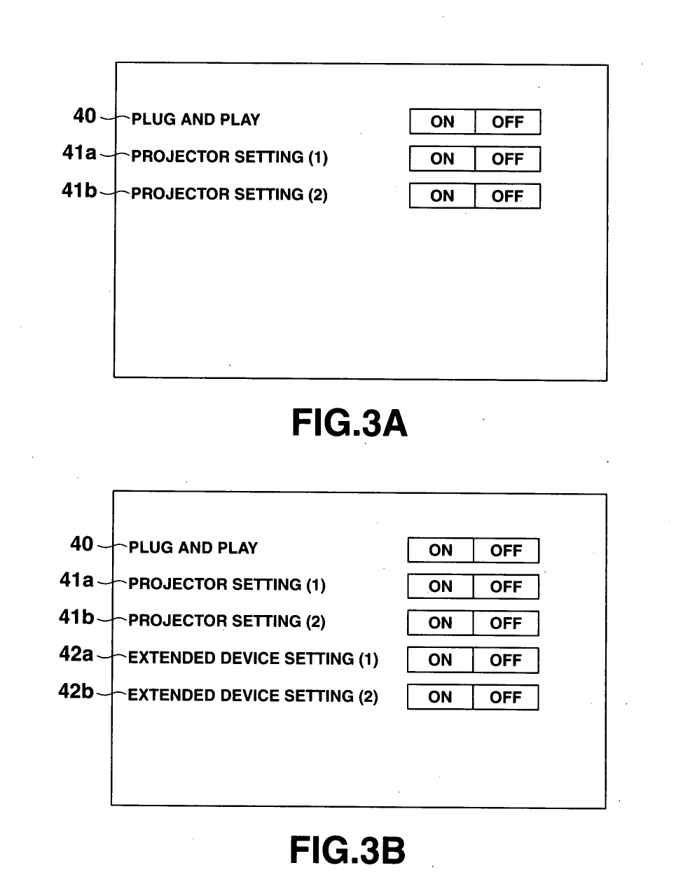

As shown in FIG. 2, remote-controller 23 has a menu key 31, which, when depressed, displays on the display screen (not shown) a main menu picture used to perform various settings, as shown in FIGS. 3A and 3B. The menu picture contains an item “plug and play on/off” 40. When one of “on” and “off” of the plug and play is selected with cursor keys 32a-32d, a plug and play function, which will be described later in greater detail, is set so.

When no extended device is connected to USB-interface 27, the menu items are set items 41a, 41b of the projector, as shown in FIG. 3A. When an extended device is connected to USB interface 27, set items 42a and 42b of the extended device are displayed additionally as shown in FIG. 3B. Arrangement may be such that when no extended device is connected to USB interface 27, set items 42a and 42b of the extended device are displayed in gray (or unsettable) while when an extended device is connected to USB interface 27, set items 42a and 42b are displayed in black (or settable).

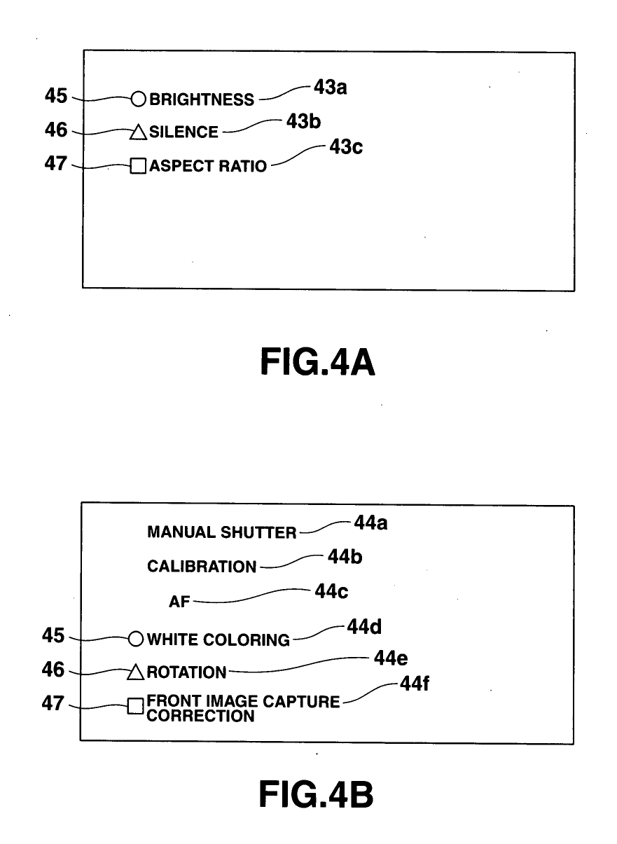

As shown in FIG. 2, remote-controller 23 has a function key 33 which displays on the display screen a function menu when depressed. When no extended device is connected to USB interface 27, function setting items “brightness” 43a, “silence” 43b and “aspect ratio” 43c of the projector are displayed as shown in FIG. 4A such that the brightness can be adjusted, that silence can be set, and that the aspect ratio can be adjusted in the projector.

When an extended device, for example a projection camera, is connected to USB interface 27, function setting items “manual shutter” 44a, “calibration” 44b for initial focus setting, “auto focus” 44c, “white coloring” 44d which reduces the number of colors of the image to increase an image color contrast, thereby allowing the image to be seen clearly, “(image) rotation” 44e, and “front image capture correction” 44f which changes an image captured sidelong as if the image were captured head-on are displayed instead as the function menu, as shown in FIG. 4B.

As shown in FIG. 2, remote-controller 23 further comprises direct-keys 34, 35 and 36. When no extended device is connected to USB interface 27, direct-key 34 has the function to directly set desired “brightness”, direct key 35 directly set “silence”, and direct key 36 directly set a desired “aspect ratio” in the projector, as shown in FIG. 4A. When a projection camera is connected to USB-interface 27, direct-key 34 has the function to directly set the “white coloring”, direct-key 35 directly set desired “image rotation”, and direct-key 36 directly perform “front image capture correction”, as shown in FIG. 4B.

Relationship between direct-keys 34-36 and their allocated functions is confirmable from the displayed function menu. More specifically, when no extended device is connected to USB-interface 27, circular, triangular, square icons 45, 46 and 47 are displayed so as to be allocated to the displayed function setting items “brightness”, “silence” and “aspect ratio”, respectively, of the projector, as shown in FIG. 4A.

As shown in FIG. 4B, it will be known that when an extended device is connected to USB-interface 27, direct-keys 34, 35 and 36 are allocated “white coloring”, “rotation” and “front image capture correction” functions, respectively. It is noted that the function menu may have more functions than the direct keys. As shown in FIG. 4B, the functions allocated to the direct keys are arranged in a lowest part of FIG. 4B, which shows that use of any direct key eliminates the necessity of selecting a corresponding function from the function menu. Even when the function menu is displayed, the direct keys can be operated for performing the corresponding functions. Immediately after the function menu is displayed, its uppermost item is emphatically displayed.

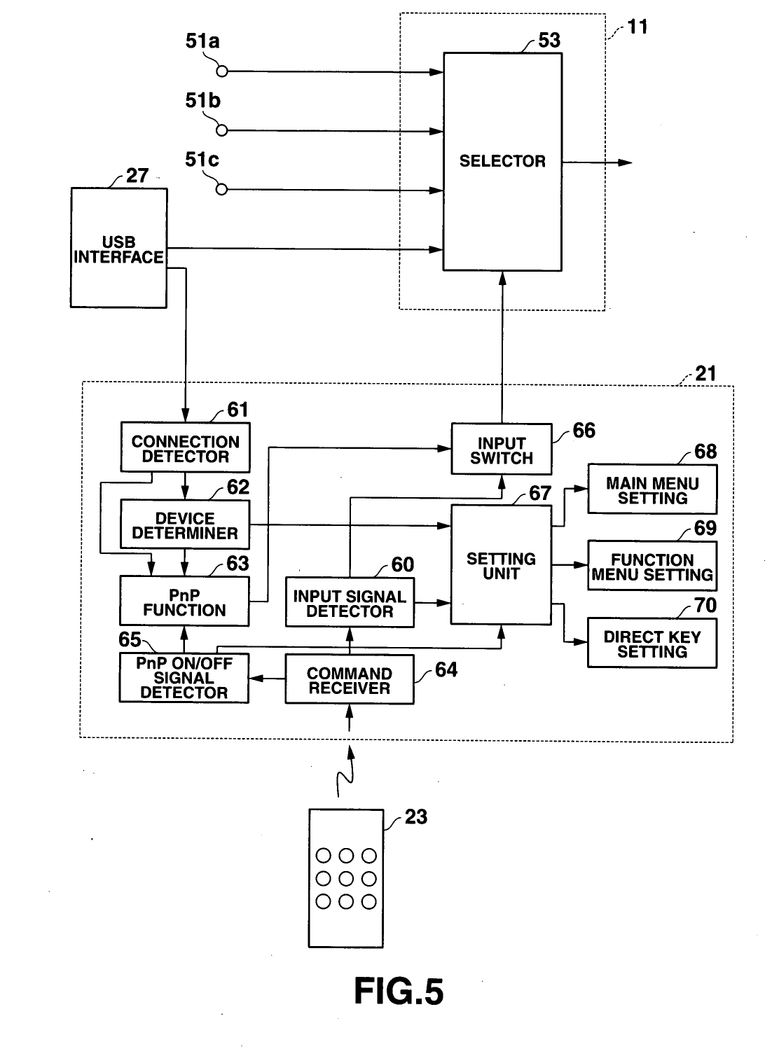

Referring to FIG. 5, an arrangement that performs the above functions is shown. Input/output interface 11 has, for example, three video input terminals 51a, 51b and 51c through which a video signal is inputted to a selector 53. Selector 53 selects a video signal from input-terminals 51a, 51b and 51c or a video signal from an extended device (not shown) through USB-interface 27. Actually, the selector that selects a video signal from input-terminals 51a-51c is different from that which selects a video signal from digital USB interface 27, but both the selectors are shown as a common selector 53 for simplifying the description.

Connection/disconnection of an extended device to/from USB interface 27 is detected by a device connection detector 61. When detector 61 detects that the extended device is connected to USB-interface 27, a device type determiner 62 determines a type of the connected device, thereby delivering a corresponding signal to a plug and play (PnP) function unit 63.

As described above, in the present embodiment an on/off function of PnP-function 63 can be set by operating remote-controller 23 manually. A PnP on/off command signal from remote-controller 23 is received by a receiver 64 and then is detected by a PnP on/off signal detector 65. Thus, on/off-signal-detector 65 delivers an on or off signal to PnP-function 63, thereby setting same in an on or off state. PnP-function 63 determines based on the device connection signal from device-connection detector 61 and the device type signal from the device type detection 63 whether the connected extended device is the one authorized to be connected to the projector. If so, PnP-function 63 further determines whether its own function is on. If so, PnP-function 63 gives an input-switch 66 a command to select a video signal from an extended device connected to USB interface 27.

When PnP function 63 is off and input-key 37 (FIG. 2) is depressed, an input signal detector 60 detects from input-key 37 a command signal to select a video signal and sends this signal to input-switch 66. In accordance with this signal, selector 53 is set so as to select a video signal from input terminals 51a, 51b and 51c.

When an extended device is connected to USB interface 27, device-type determiner 62 determines the type of the extended device and then sends a device type determination signal to a setting unit 67. Setting-unit 67 then causes a menu display setting unit 68, a function display setting unit 69 and a direct key setting unit 70 to be set, as shown in FIGS. 3B and 4B.

Processing by the projector as the embodiment of the invention will be described with reference to flowcharts.

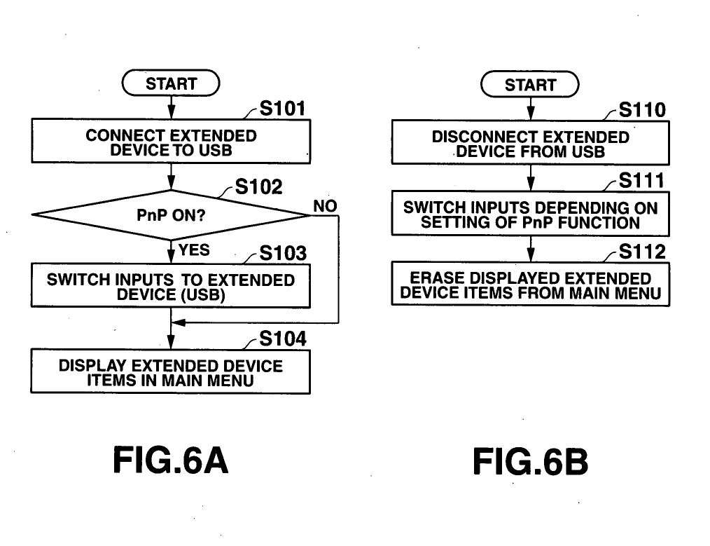

In FIG. 6A, when an extended device is connected to USB-interface 27 (step S101), it is determined whether PnP-function 63 is on or off (step S102). If PnP-function 63 is on, selector 53 is switched so as to receive a video signal from the extended device (step S103) and an item for the extended device is displayed in the menu, as shown in FIG. 3B (step S104). If PnP-function 63 is off, the inputs to selector 53 are not switched, and the item for the extended device is displayed in the menu.

When the extended device is disconnected from USB-interface 27 in FIG. 6B (step S110), the inputs to selector 53 are switched depending on whether PnP function 63 is on or off (step S111), and a (black) displayed item for the extended device in the menu disappears (step S112). In this case, the black displayed item may be changed gray.

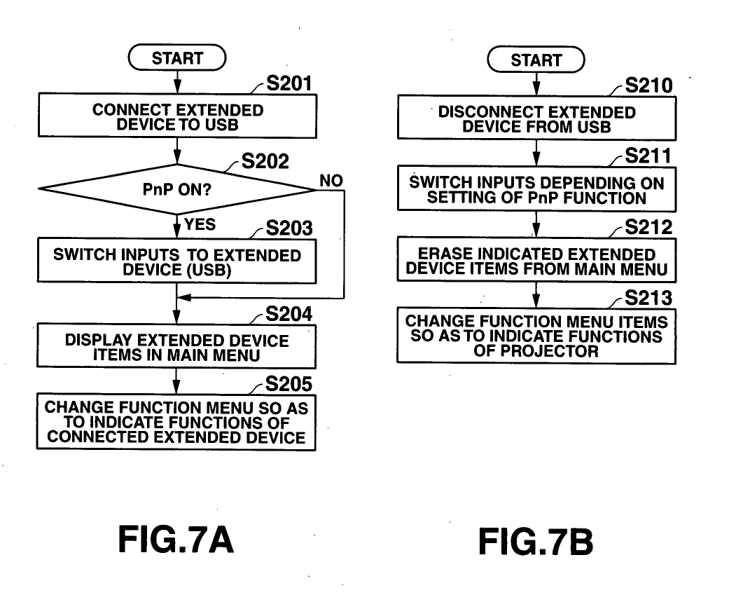

FIGS. 7A and 7B show change of display of the function menu depending on whether an extended device is connected to USB interface 27. In FIG. 7A, when the extended device is connected to USB-interface 27 (step S201), it is determined whether PnP-function 63 is on (step S202). If so, the inputs to selector 53 are selected so as to receive a video signal from the extended device (step S203) and the item for the extended device is displayed in the menu, as shown in FIG. 3B (step S204). Further, the items in the function menu are changed depending on the extended device (step S205). When PnP-function 63 is off in step S202, the inputs to selector 53 are not switched by PnP-function 63 and the item for the extended device is displayed in the menu (step S204). Then, in step S205 the items in the function menu are changed depending on the connected extended device.

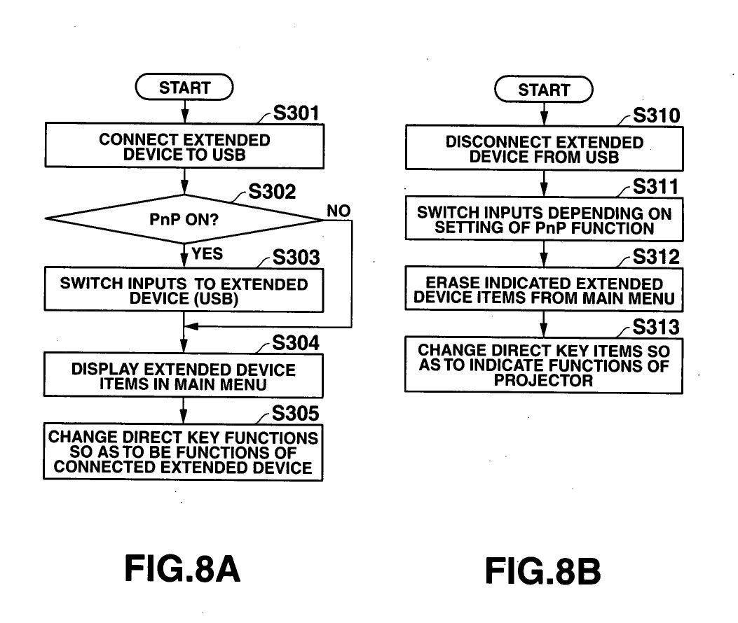

FIGS. 8A and 8B show change of the functions of direct keys 34-36 when the extended device is connected to and disconnected, respectively, from USB interface 27. In FIG. 8A, when the extended device is connected to USB-interface 27 (step S301), it is determined whether PnP-function 63 is on (step S302). If so, the inputs to selector 53 are selected so as to receive a video signal from the extended device (step S303) and the item for the extended device is displayed in the menu, as shown in FIG. 3B (step S304). Further, the functions of direct-keys 34-36 are changed depending on the extended device (step S505). When PnP-function 63 is off in step S302, the inputs to selector 53 are not switched by PnP-function 63 and then the item for the extended device is displayed in the menu (step S202). Then, in step S305 the functions of direct-keys 34-36 are changed depending on the extended device.

When the extended device is disconnected from USB-interface 27 in FIG. 8B (step S310), the inputs to selector 53 are switched depending on whether PnP-function 63 is on or off (step S311). Then, the (black) displayed items for the extended device in the main menu disappear (step S312). Then, the items of direct-keys 34-36 are changed so as to be the functions of the projector (step S313).

While the function menu or the direct key functions are illustrated as changed when the extended device is connected to USB-interface 27 in the embodiment, it may be changed when the input-key 37 selects the extended device.

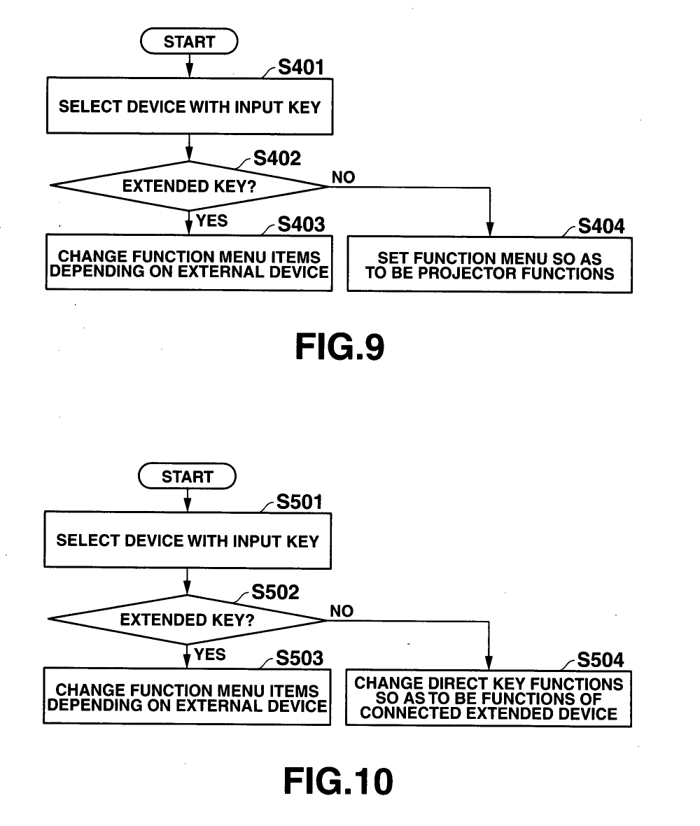

FIG. 9 shows a process for changing the function menu when input-key 37 selects an extended device. In FIG. 9, when input-key 37 selects the inputs to selector 53 (step S401), it is determined whether the selected device is an extended one (step S402). If so, the items in the function menu are changed (depending on the extended device), as shown in FIG. 4B (step S403). If not in step S402, the function menu is set so as to be the functions of the projector (step S404).

In FIG. 10, when input-key 37 selects a device (step S501), it is determined whether the selected device is an extended one (step S502). If so, the functions of direct-keys 34-36 are changed depending on the extended device, as shown in FIG. 4B (step S503). If not in step S502, the functions of the direct keys are set so as to be the functions of the projector (step S504).

As described above, in the projector of the embodiment, PnP-function 63 can be set to on or off. When PnP-function 63 is on, and a device is connected to USB-interface 27, it is determined whether the connected device is an extended one. If so, selector 53 is switched automatically so as to select a video signal from the extended device. When PnP-function 63 is off, a desired input video signal can be selected depending on a set state of the input key. Even when an extended device is connected to the USB interface while the projector is projecting an image on a screen in the off state of PnP-function 63, selector 53 is prevented from being compulsively switched to the extended device.

When an extended device is connected to USB-interface 27 in the projector of the embodiment, the main menu, the function menu and the direct key functions are changed depending on the functions of the extended device. Thus, the extended device can be set using the remote controller of the projector.

While in the embodiment the input key is illustrated as provided in the remote controller, that key may be provided in the projector. The present invention is applicable to video devices such as television receivers and VTRs, in addition to the projectors, to which an extended device can be connected through the USB interface.

The present invention has been described with reference to several exemplary embodiments and modifications. However, it will be readily apparent to those skilled in the art that it is possible to embody the invention in specific forms other than those of the exemplary embodiments and modifications described above. This may be done without departing from the spirit of the invention. These exemplary embodiments and modifications are merely illustrative and should not be considered restrictive in any way. The scope of the invention is given by the appended claims, rather than the preceding description, and all variations and equivalents which fall within the range of the claims are intended to be embraced therein.

This application is based on Japanese Patent Application No. 2006-156912 filed on Jun. 6, 2006 and including specification, claims, drawings and summaries. The disclosures of the above Japanese patent applications are incorporated herein by reference in their entireties.

What is claimed is:

1. A video device including an input terminal over which a video signal is received externally, a digital interface to which an extended device that provides a video signal is connectable, and a projecting unit that projects on a display screen a video based on the video signal from the plurality of input terminals or the video signal from the extended device, the video device comprising:
a device connection detector that detects that the extended device is connected to the digital interface;
a device type determiner that determines a type of the extended device connected to the digital interface;
a plug and play function unit that, responsive to the device connection detector and the device type determiner, selects the extended device;
an on/off setting unit that sets the plug and play function unit to on or off; and
an input switch, responsive to the selection of the extended device connected to the digital interface and the plug and play function unit being set to on, for selecting the video signal from the extended device so as to be inputted to the video device, and responsive to the selection of the extended device connected to the digital interface and the plug and play function unit being set to off, for failing to select the video signal from the extended device.

2. The video device of claim 1, further comprising an indicator that sets operation of the extended device and a setting unit, responsive to the extended device being connected to the digital interface, for validating the indicator.

3. The video device of claim 2, further comprising a main menu indicator that sets operation of the extended device, and a main menu setting unit that, responsive to the extended device being connected to the digital interface, validates indication of the main menu indicator and that, responsive to the extended device being disconnected from the digital interface, invalidates the indication of the main menu indicator.

4. The video device of claim 2, further comprising a function menu indicator that when the extended device is disconnected from the digital interface, indicates a function menu to set operation of the video device, and that when the extended device is connected to the digital interface, indicates a second function menu to set operation of the extended device.

5. The video device of claim 2, further comprising a direct key that when the extended device is disconnected from the digital interface, sets operation of the video device, and that when the extended device is connected to the digital interface, sets operation of the extended device.

6. The video-device of claim 2, further comprising a function menu indicator that when the extended device connected to the digital interface is not selected, sets operation of the video device, and that when the extended device connected to the digital interface is selected, sets operation of the extended device instead of the first-mentioned function menu.

7. The video device of claim 2, further comprising a direct key that when the extended device connected to the digital interface is not selected, sets operation of the video device, and that when the extended device connected to the digital interface is selected, sets operation of the extended device.

8. A video image displaying method in a video device for projecting and displaying a video image on a display screen based on a video image signal received externally over an input terminal or over a digital interface to which an extended device that produces a video signal is connectable, the method comprising the steps of:
detecting that the extended device is connected to the digital interface;
determining a type of the extended device connected to the digital interface;
detecting whether a plug and play function is on or off; and
responsive to the extended device connected to the digital interface and the plug and play function unit set to on, selecting the video signal from the extended device, and responsive to the extended device connected to the digital interface and the plug and play function unit set to off, failing to select the video signal from the extended device.

9. The video image displaying method of claim 8, further comprising the step of validating an indicator for setting operation of the extended device responsive to the extended device being connected to the digital interface.

10. A software program product embodiment in a computer readable medium for performing the method of claim 8.

11. The software program product embodiment in a computer readable medium for performing the method of claim 10.
